(19) United States
(12) Patent Application Publication
(10) Pub. No.: US 2025/0246371 A1
(43) Pub. Date: Jul. 31, 2025

(54) CAPACITOR

(71) Applicant: Murata Manufacturing Co., Ltd., Nagaokakyo-shi (JP)

(72) Inventors: Tatsuki NISHIJIMA, Nagaokakyo-shi (JP); Akio Masunari, Nagaokakyo-shi (JP)

(21) Appl. No.: 19/184,013

(22) Filed: Apr. 21, 2025

Related U.S. Application Data
(63) Continuation of application No. PCT/JP2024/027075, filed on Jul. 30, 2024.

(30) Foreign Application Priority Data
Jan. 9, 2024 (JP) 2024-001237

(51) Int. Cl. H01G 4/228; H01G 4/224

(52) U.S. Cl. CPC H01G 4/228; H01G 4/224

(57) ABSTRACT

A capacitor that includes: an insulating substrate having a first main surface; a capacitance forming part on the main surface, the capacitance forming part including a conductive metal porous body, a dielectric film covering a surface of the conductive metal porous body, and a conductive film covering the dielectric film; a first external connection line connected to the conductive metal porous body; and a second external connection line connected to the conductive film, the second external connection line including a conductive plating part on an outer peripheral part of the capacitance forming part, and a conductive interposing film interposed between the capacitance forming part and the plating part, wherein the capacitance forming part is sealed by the insulating substrate and the conductive plating part.

### CROSS REFERENCE TO RELATED APPLICATIONS

The present application is a continuation of International application No. PCT/JP2024/027075, filed Jul. 30, 2024, which claims priority to Japanese Patent Application No. 2024-001237, filed Jan. 9, 2024, the entire contents of each of which are incorporated herein by reference.

### TECHNICAL FIELD

The present disclosure relates to a capacitor.

### BACKGROUND ART

For example, WO 2018/092722 A (Patent Document 1) discloses a capacitor including a capacitance forming part provided by a metal porous body, a dielectric film covering the surface of the metal porous body, and a conductive film covering the dielectric film. In the capacitor, the capacitance forming part is sealed by a conductive plating part.

### SUMMARY OF THE DISCLOSURE

Here, in the capacitor disclosed in Patent Document 1 above, a plating solution for forming a plating part may remain in a plurality of fine spaces provided inside the capacitance forming part. In this case, the blister is generated by expansion of the plating solution due to a thermal load or the like applied at the time of manufacturing or after mounting the capacitor, and there is a concern that the dielectric film is cracked by applying stress to the capacitance forming part. When the residue of the plating solution may come into contact with the metal porous body, there is also a concern that the metal porous body is dissolved.

In this way, when the formation of cracks in the dielectric film, the dissolution of the metal porous body, or the like occurs, a short circuit of the capacitance forming part is caused, and as a result, the function as a capacitor is deteriorated.

Accordingly, the present disclosure has been made to solve the problem mentioned above, and an object of the present disclosure is to achieve improved reliability after mounting in a capacitor including a capacitance forming part including a metal porous body, a dielectric film, and a conductive film and a plating part sealing the capacitance forming part.

A capacitor based on the present disclosure includes: an insulating substrate having a first main surface; a capacitance forming part on the main surface, the capacitance forming part including a conductive metal porous body, a dielectric film covering a surface of the conductive metal porous body, and a conductive film covering the dielectric film; a first external connection line connected to the conductive metal porous body; and a second external connection line connected to the conductive film, the second external connection line including a conductive plating part on an outer peripheral part of the capacitance forming part, and a conductive interposing film interposed between the capacitance forming part and the plating part, wherein the capacitance forming part is sealed by the insulating substrate and the conductive plating part.

According to the present disclosure, it is possible to achieve improved reliability after mounting in a capacitor including a capacitance forming part including a metal porous body, a dielectric film, and a conductive film, and a plating part sealing the capacitance forming part.

### BRIEF EXPLANATION OF THE DRAWINGS

FIG. 1 is a schematic front view of a capacitor according to a first embodiment.

FIG. 2 is a schematic bottom view of the capacitor illustrated in FIG. 1.

FIG. 3 is a schematic sectional view of the capacitor illustrated in FIG. 2.

FIG. 4 is an enlarged sectional view of a main part of the capacitor illustrated in FIG. 3.

FIG. 5 is an enlarged sectional view of a main part for explaining an example of a distance measurement method.

FIG. 6 is a flowchart illustrating a method for manufacturing the capacitor according to the first embodiment.

FIG. 7 is a schematic sectional view illustrating a state after completing step S4 of a manufacturing flow illustrated in FIG. 6.

FIG. 8 is a schematic sectional view for explaining step S5 of the manufacturing flow illustrated in FIG. 6.

FIG. 9 is a schematic sectional view for explaining step S6 of the manufacturing flow illustrated in FIG. 6.

FIG. 10 is a schematic sectional view for explaining step S7 of the manufacturing flow illustrated in FIG. 6.

FIG. 11 is a schematic sectional view for explaining step S8 of the manufacturing flow illustrated in FIG. 6.

FIG. 12 is a schematic sectional view for explaining step S9 of the manufacturing flow illustrated in FIG. 6.

FIG. 13 is a schematic sectional view of a capacitor according to a first modification example.

FIG. 14 is a schematic sectional view of a capacitor according to a second modification example.

FIG. 15 is a schematic sectional view of a capacitor according to a second embodiment.

FIG. 16 is an enlarged sectional view of a main part of the capacitor illustrated in FIG. 15.

FIG. 17 is a flowchart illustrating a method for manufacturing the capacitor according to the second embodiment.

### DESCRIPTION OF THE PREFERRED EMBODIMENTS

Hereinafter, embodiments of the present disclosure will be described in detail with reference to the drawings. Note that in the following embodiments, the same or common parts are denoted by the same reference numerals in the drawings, and description thereof will not be repeated. In addition, while the terms of “positive electrode” and “negative electrode” are used in the following embodiments for convenience of description, the electric polarities of capacitors according to the following embodiments are not to be considered uniquely determined by these terms, and the electric polarities are determined appropriately depending on the use environments of the capacitors.

### First Embodiment

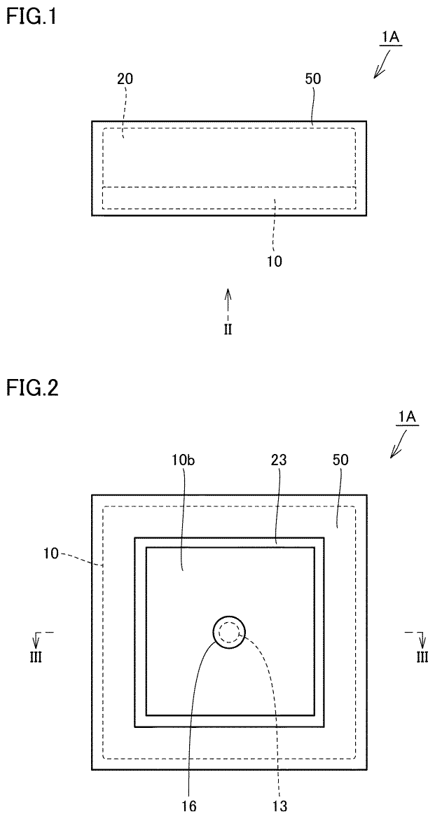

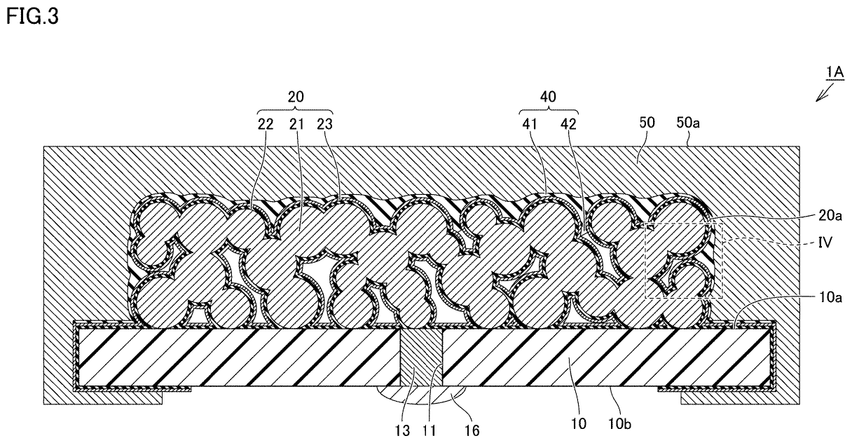

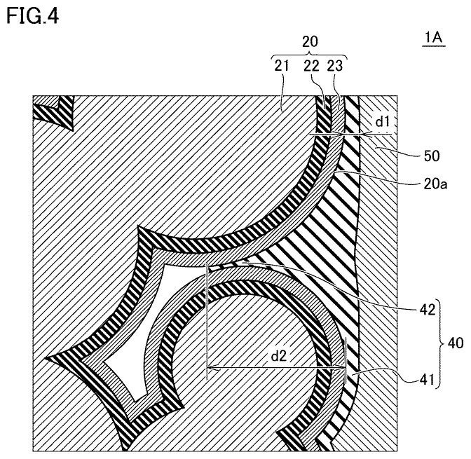

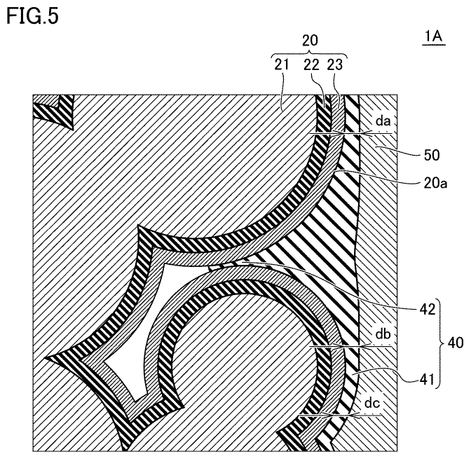

FIG. 1 is a schematic front view of a capacitor according to a first embodiment. FIG. 2 is a schematic bottom view of the capacitor as viewed from a direction of an arrow II illustrated in FIG. 1. FIG. 3 is a schematic sectional view of the capacitor taken along line III-III illustrated in FIG. 2. FIG. 4 is an enlarged sectional view of a main part of region IV in the capacitor illustrated in FIG. 3. FIG. 5 is an enlarged sectional view of a main part for explaining an example of a distance measurement method. First, a configuration of a capacitor 1A according to the present embodiment will be described with reference to FIGS. 1 to 5. Note that the region illustrated in FIG. 5 is similar to the region illustrated in FIG. 4.

As illustrated in FIGS. 1 to 4, the capacitor 1A has a flat and substantially rectangular parallelepiped outer shape, and a bottom surface thereof is configured as a mounting surface for a wiring board or the like. The capacitor 1A mainly includes an insulating substrate 10, a capacitance forming part 20, and a plating part 50. The capacitance forming part 20 is provided to face the insulating substrate 10. The capacitance forming part 20 is sealed by the insulating substrate 10 and the plating part 50 of a portion provided on the insulating substrate 10 to be located inside the capacitor 1A.

The insulating substrate 10 is provided with a first via conductor 13 and a first bump 16. The first via conductor 13 and the first bump 16 constitute one of a pair of external connection lines for electrically connecting the capacitance forming part 20 located inside the capacitor 1A to an external circuit. More specifically, the pair of external connection lines includes a first external connection line as a positive electrode and a second external connection line as a negative electrode. The first external connection line includes the first via conductor 13 and the first bump 16. The second external connection line is formed of the plating part 50 and the like, which will be described later in detail.

The insulating substrate 10 is made of a flat plate-like member having a first main surface 10a as a main surface and a second main surface 10b located on the side opposite to the first main surface 10a. As the insulating substrate 10, a substrate that has an electrical insulation property is preferably used, and a substrate containing an inorganic material as a main component can be suitably used. More specifically, as the insulating substrate 10, for example, a substrate containing, as a main material, any of Si, Al₂O₃, ZrO₂, BN, Si₃N₄, AlN, MgO, Mg₂SiO₄, BaTiO₃, SrTiO₃, and CaTiO₃ can be used.

The thickness and size of the insulating substrate 10 are not particularly limited, but it is preferable to use, for example, an alumina substrate that has a rectangular shape of 5 μm to 75 μm in thickness and of 500 μm to 2000 μm on a side in plan view.

The insulating substrate 10 is provided with a first through-hole 11. The first through-hole 11 penetrates the insulating substrate 10 so as to reach the second main surface 10b from the first main surface 10a. The first through-hole 11 is filled with the first via conductor 13. The first via conductor 13 has, for example, a substantially columnar shape.

The first via conductor 13 constitutes a part of the first external connection line described above. When viewed in a normal direction of the first main surface 10a of the insulating substrate 10, the first via conductor 13 is provided in a region where the capacitance forming part 20 is disposed.

The first via conductor 13 can be made of various wiring materials, and is preferably made of a metal material having particularly high electrical conductivity. A material of the first via conductor 13 can be, for example, a metal material containing as a main material any one of Ni, Ag, Cu, Au, Pt, Mo, and W. The material of the first via conductor 13 can be appropriately changed according to the mounting environment of the capacitor 1A according to the present embodiment. According to the present embodiment, the first via conductor 13 made of Ni is used.

The axial length and the size of the first via conductor 13 are not particularly limited, and are appropriately set according to the thickness and the size of the insulating substrate 10. In this regard, the axial length of the first via conductors 13 is preferably, for example, 5 μm to 75 μm, and the diameter thereof is preferably, for example, 15 μm to 150 μm. In the present embodiment, a conductor made of Ni having an axial length of 75 μm and a diameter of 150 μm is used as the first via conductor 13.

The first bump 16 is provided on the second main surface 10b of the insulating substrate 10 so as to cover the first via conductor 13. The first bump 16 serves as a joining material for mounting the capacitor 1A on a wiring board or the like and electrically connecting the capacitance forming part 20 of the capacitor 1A to an external circuit. The first bump 16 is provided to protrude from the second main surface 10b of the insulating substrate 10. The shape of the first bump 16 is substantially hemispherical. The first bump 16 constitutes a part of the first external connection line described above.

The first bump 16 can be made of various wiring materials, and is preferably made of a metal material having particularly high electrical conductivity. The material of the first bump 16 can be, for example, a metal material containing, as a main material, any of Ni, Ag, Cu, Au, and Sn. According to the present embodiment, the first bump 16 made of Au is used.

The size of the first bump 16 is not particularly limited, and is appropriately set according to the size of the first via conductor 13.

As illustrated in FIG. 3, the capacitance forming part 20 is provided on the first main surface 10a of the insulating substrate 10. The capacitance forming part 20 includes a conductive metal porous body 21 having a plurality of fine pores therein, a dielectric film 22 covering a surface of the metal porous body 21, and a conductive film 23 further covering a surface of the dielectric film 22.

The metal porous body 21 is connected to the first via conductor 13. At least a part of the plurality of fine pores provided inside the metal porous body 21 are not closed by the metal porous body 21 itself, and preferably, most or all of the plurality of fine pores provided inside the metal porous body 21 are not closed by the metal porous body itself. Such a metal porous body 21 is made of, for example, a sintered body of metal particles.

The metal porous body 21 can be made of various conductive metal materials, and is preferably made of a metal material containing, as a main material, any of Ni, Mo, W, Al, Ti, Ta, Nb, Cu, Pt, Au, and Ag. In addition, the metal porous body 21 may be made of an alloy material containing, as main components, two or more selected from these metal materials.

The thickness and size of the metal porous body 21 are not to be considered particularly limited, and in particular, the size is appropriately set depending on the size of the insulating substrate 10. In the present embodiment, the metal porous body 21 made of Ni and having a thickness of 200 μm is used.

The metal porous body 21 is preferably made of a sintered body of metal particles. In that case, metal particles that have various shapes such as a spherical shape, an elliptical spherical shape, a flat shape, a plate shape, and a needle shape can be used. In addition, the particle sizes of the metal particles are not to be considered particularly limited, but the average particle size thereof is preferably 600 nm or less, more preferably 20 nm to 500 nm.

The dielectric film 22 covers the surface of the metal porous body 21 as described above. More specifically, the dielectric film 22 covers not only the surface of the metal porous body 21 of a portion located on the outermost side of the capacitance forming part 20 but also a surface defined by the above-described fine pores which are not closed by the metal porous body itself out of the surface of the metal porous body 21 of a portion located inside the capacitance forming part 20. The dielectric film 22 covers a side surface of the insulating substrate 10 and an edge portion of the second main surface 10b.

The dielectric film 22 can be made of various insulating materials, and can be made of, for example, a metal oxide such as AlOₓ, SiOₓ, HfOₓ, TiOₓ, TaOₓ, ZrOₓ, SiAlOₓ, HfAlOₓ, ZrAlOₓ, AlTiOₓ, SrTiOₓ, HfSiOₓ, ZrSiOₓ, TiZrOₓ, TiZrWOₓ, BaTiOₓ, PbTiOₓ, BaSrTiOₓ, and BaCaTiOₓ, a metal nitride such as AlNₓ, SiNₓ, and AlScNₓ, and a metal oxynitride such as AlOₓN_{y}, SiOₓN_{y}, HfOₓN_{y}, and SiCₓO_{y}N_{z}. Among the materials, the dielectric film 22 is preferably made of any of AlOₓ (for example, Al₂O₃), SiOₓ (for example, SiO₂), HfOₓ, TiOₓ, SiAlOₓ, HfAlOₓ, ZrAlOₓ, HfSiOₓ, and ZrSiOₓ. Note that the chemical formulas mentioned above are merely intended to represent the constitutions of the materials, and are not intended to limit the composition. More specifically, x, y, and z attached to O, N, and C may be any value larger than 0, and the abundance ratios of the respective elements including the metal elements are arbitrary. In addition, the dielectric film 22 may be made of a laminated film including a plurality of dielectric layers that differ in material.

The dielectric film 22 can be preferably formed by a gas phase method, for example, a vacuum deposition method, a chemical vapor deposition (CVD) method, a sputtering method, an atomic layer deposition (ALD) method, a pulsed laser deposition (PLD) method, or the like, or a method of using a supercritical fluid, and is particularly preferably formed by the ALD method.

The thickness of the dielectric film 22 is not particularly limited, but is preferably 3 nm to 100 nm, and more preferably 5 nm to 50 nm. In the present embodiment, the dielectric film 22 made of AlSiO and having a thickness of about 20 nm is used.

The conductive film 23 covers the surface of the dielectric film 22 as described above. More specifically, the conductive film 23 covers not only the surface of the dielectric film 22 of the portion located on the outermost side of the capacitance forming part 20 but also the surface of the dielectric film 22 of the portion located inside the capacitance forming part 20. The conductive film 23 covers the surface of the dielectric film 22 of a portion covering the side surface of the insulating substrate 10, and the surface of the dielectric film 22 of a portion covering the surface of the edge portion of the second main surface 10b.

The conductive film 23 can be made of various conductive materials, and can be made of a metal material containing, as a main material, any of Ni, Cu, Ru, Al, W, Ti, Ag, Au, Zn, Ta, and Nb, an alloy material containing, as main components, two or more selected from these metal materials, a metal nitride such as TiN, TiAlN, TiSiN, TaN, NbN, and WN, a metal oxynitride such as TiON or TiAlON, a conductive polymer such as poly(3,4-ethylenedioxythiophene) (PEDOT), polypyrrole, and polyaniline, or a conductive oxide film such as RuO₂, ZnO, (Zn, Al)O, and NiO.

The conductive film 23 can be preferably formed by a CVD method, an ALD method, a PLD method, a plating method, a bias sputtering method, a sol-gel method, a method of using conductive polymer filling, or a method of using a supercritical fluid, and is particularly preferably formed by an ALD method. In addition, the conductive film 23 may be made of a laminated film including a plurality of dielectric layers that differ in material. In that case, after film formation is performed by an ALD method, film formation can be performed by another method.

The thickness of the conductive film 23 is not particularly limited, but is preferably 3 nm or more, and more preferably 10 nm or more. In the present embodiment, the conductive film 23 made of TiN and having a thickness of about 25 nm is used.

As illustrated in FIGS. 3 and 4, an outer peripheral part 20a of the capacitance forming part 20 is covered with a conductive interposing film 40. More specifically, the interposing film 40 includes an outer portion 41 located between the conductive film 23 in a portion defining the outer peripheral part 20a of the capacitance forming part 20 and the plating part 50 without entering a space inside the capacitance forming part 20. As a result, the interposing film 40 is interposed between the capacitance forming part 20 and the plating part 50. Here, the “outer peripheral part of the capacitance forming part” means a portion that winds around the outside of the capacitance forming part, and whereby the shape of the capacitance forming part is not limited to, for example, a columnar shape, a spherical shape, or the like.

The interposing film 40 further includes an inner portion 42 entering the space inside the capacitance forming part 20.

By configuring the interposing film 40 in this way, it is possible to effectively suppress the occurrence of a short circuit in the capacitance forming part 20, but the details thereof will be specifically described later.

A distance (see a distance d1 in FIG. 4) between a portion of the outer portion 41 of the interposing film 40 in contact with the plating part 50 and the outer peripheral part 20a of the capacitance forming part 20 in a thickness direction of the interposing film 40 is preferably 100 nm or more.

Meanwhile, a distance (see a distance d2 in FIG. 4) between a portion of the inner portion 42 of the interposing film 40 which is the deepest in the space inside the capacitance forming part 20 and the outer peripheral part 20a of the capacitance forming part 20 in the thickness direction of the interposing film 40 is preferably 15 μm or less. This is because, when the distance is considerably large, the film stress generated in the interposing film 40 increases, which may cause the capacitance forming part 20 to be peeled off from the insulating substrate 10.

The interposing film 40 can be made of various conductive materials, and can be made of a metal material containing, as a main material, any of Ni, Cu, Ru, Al, W, Ti, Ag, Au, Zn, Ta, and Nb, an alloy material containing, as main components, two or more selected from these metal materials, a metal nitride such as TiN, TiAlN, TiSiN, TaN, NbN, and WN, a metal oxynitride such as TiON or TiAlON, a conductive polymer such as poly(3,4-ethylenedioxythiophene) (PEDOT), polypyrrole, and polyaniline, or a conductive oxide film such as RuO₂, ZnO, (Zn, Al)O, and NiO. In the present embodiment, the interposing film 40 made of Cu is used.

The interposing film 40 can be preferably formed by a CVD method, an ALD method, a PLD method, a bias sputtering method, a sol-gel method, a method of using conductive polymer filling, or a method of using a supercritical fluid, and is particularly preferably formed by a CVD method.

Note that the above-described distances d1 and d2 are measured by, for example, observing a section orthogonal to the extending direction of the first main surface 10a of the insulating substrate 10 using a scanning ion microscope (SIM). Hereinafter, a method of measuring the distance d1 will be described as an example with reference to FIG. 5. Note that, a method of measuring the distance d2 can be performed by a method according to the method of measuring the distance d1.

When the longitudinal direction of the capacitor 1A in plan view of the capacitor 1A, the lateral direction thereof, and the thickness direction (that is, the normal direction of the first main surface 10a) of the capacitor 1A are denoted respectively by Lx, Ly, and Lz, first, the capacitor 1A is subjected to a polishing treatment so as to expose an Lx-Lz section of a part of the capacitor 1A located at the center in the Ly direction. The polishing treatment is performed such that the exposed section is located within an error range of ±100 μm in the Ly direction with the central position as a reference.

Next, a portion in the vicinity of the outer peripheral part 20a of the capacitance forming part 20 in the exposed section is observed at a magnification of 50000 times with the use of a SIM. The observation range of the section in the Lz direction is a range of ±50 μm based on the central position of the section in the Lz direction.

Next, in the observation range of the section, the distance between a portion of the outer portion 41 of the interposing film 40 in contact with the plating part 50 and the outer peripheral part 20a of the capacitance forming part 20 in the thickness direction of the interposing film 40 is measured at ten places at equal intervals in the Lz direction. Note that, when the measurement is performed at these ten points, an interval in the Lz direction between adjacent measurement points is set to 200 nm or more.

Next, among ten measured values thus obtained, an average value of a total of six measured values excluding the maximum value, the secondly larger value, the minimum value, and the excluding smaller value is calculated. The average value calculated in this manner is the above-described distance d1. In this regard, in FIG. 5, three of the distances measured at these ten points are illustrated as line segment lengths da, db, and dc.

Note that, although the measurement point is determined based on the SIM image, the length measurement may be performed based on an image at a magnification of 200000 times with the use of a transmission electron microscope (TEM).

As illustrated in FIGS. 1 to 3, the plating part 50 is provided on the outer peripheral part 20a of the capacitance forming part 20. Thus, the capacitance forming part 20 is sealed by the insulating substrate 10 and the plating part 50. The plating part 50 defines an outer surface 50a located on a side opposite to the insulating substrate 10 side as viewed from the capacitance forming part 20. More specifically, the plating part 50 is located so as to cover the upper side and the lateral side of the capacitance forming part 20 provided to face the first main surface 10a of the insulating substrate 10. Note that, as described above, the interposing film 40 is interposed between the capacitance forming part 20 and the plating part 50.

The plating part 50 is also provided on the side surface and a part of the second main surface 10b of the insulating substrate 10. More specifically, the plating part 50 is provided so as to cover most of the surface of the conductive film 23 of a portion located on the side surface of the insulating substrate 10 and the surface of the edge portion of the second main surface 10b. In the capacitor 1A according to the present embodiment, the capacitance forming part 20 is configured to be capable of electrically extending from the plating part 50 of a portion formed in an annular shape along the edge portion of the second main surface 10b of the insulating substrate 10.

That is, in the present embodiment, the above-described first bump 16 and the plating part 50 of the portion formed in an annular shape along the edge portion of the second main surface 10b of the insulating substrate 10 define the bottom surface of the capacitor 1A, so that the bottom surface thereof is configured as a mounting surface for a wiring board or the like.

The plating part 50 can be made of various conductive materials, and is preferably made of a metal material having particularly high electrical conductivity. A material of the plating part 50 can be a metal material made of, for example, any of Ni, Ag, Cu, Au, Pt, Mo, and W as a main material. In the present embodiment, the plating part 50 made of Cu is used. The plating part 50 can be formed by various plating methods.

The thickness and size of the plating part 50 are not to be considered particularly limited, and the size is appropriately set depending on the size of the insulating substrate 10. In this regard, the thickness of the plating part 50 is preferably, for example, 0.5 μm to 50 μm, and the size is preferably, for example, such a size that covers the entire surface of the first main surface 10a of the insulating substrate 10.

The second external connection line, which is the other of the pair of external connection lines for electrically connecting the capacitance forming part 20 to an external circuit, includes the interposing film 40 and the plating part 50 described above.

With the foregoing configuration, in the capacitor 1A according to the present embodiment, an electrical extension of the capacitance forming part 20 including the conductive metal porous body 21, the dielectric film 22, and the conductive film 23 is achieved by the pair of external connection lines. More specifically, in the capacitor 1A, the first external connection line includes the first via conductor 13 and the first bump 16, and the metal porous body 21 of the capacitance forming part 20 is connected to the first via conductor 13. In the capacitor 1A, the second external connection line includes the interposing film 40 and the plating part 50, and the conductive film 23 of the capacitance forming part 20 is connected to the plating part 50 with the interposing film 40 interposed therebetween.

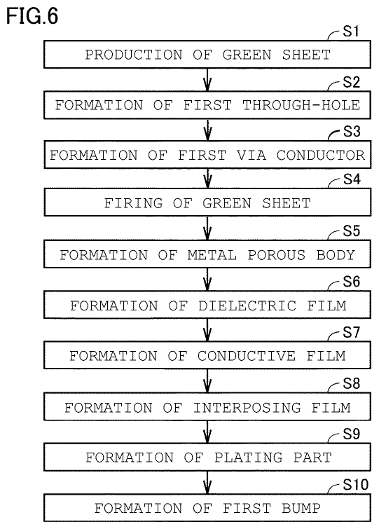

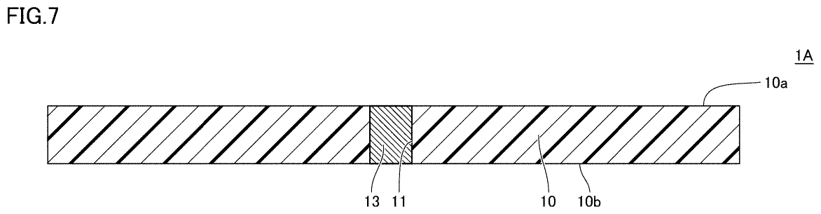

FIG. 6 is a flowchart illustrating a method for manufacturing the capacitor according to the present embodiment. FIGS. 7 to 12 are schematic sectional views for illustrating respective steps of the manufacturing flow illustrated in FIG. 6. Next, an example of a specific manufacturing method for manufacturing the capacitor 1A according to the present embodiment described above will be described with reference to FIGS. 6 to 12.

In manufacturing the capacitor 1A according to the present embodiment, first, as illustrated in FIG. 6, a green sheet is produced in step S1. Specifically, an Al₂O₃ powder and glass powder are weighed, and the Al₂O₃ powder and the glass powder, an organic solvent such as toluene or ethanol, and a binder such as polyvinyl butyral are mixed. Thereafter, the mixture is formed into a sheet shape, thereby producing a green sheet as a base for the insulating substrate.

Next, as illustrated in FIG. 6, in step S2, the first through-hole is formed in the green sheet. Specifically, the first through-hole 11 to be embedded later by the first via conductor 13 which is a part of the positive electrode is provided at a predetermined position of the green sheet.

In this regard, a method for forming the first through-holes 11 is not to be considered particularly limited, but for example, the first through-hole 11 can be formed by irradiating the green sheet with laser light. In addition, the first through-hole 11 may also be formed by processing with a mechanical puncher used or sandblasting.

Next, as illustrated in FIG. 6, in step S3, the first via conductor is formed in the green sheet with the first through-hole formed. Specifically, a conductive paste is applied to the green sheet so as to embed the first through-holes 11.

In this regard, the method for applying the conductive paste is not to be considered particularly limited, but for example, a screen printing method can be used.

Next, as illustrated in FIG. 6, in step S4, the green sheet to which the conductive paste is applied is fired. The green sheet is fired, for example, under a temperature condition of 700° C. to 1000° C. in an air atmosphere.

Through steps S1 to S4 described above, the insulating substrate as illustrated in FIG. 7 is obtained.

In the foregoing description, a case where the green sheet and the conductive paste are simultaneously fired has been described as an example; however, the first via conductor 13 may be provided after firing the insulating substrate without the first through-hole or the like provided. In this case, the first through-hole 11 may be provided in the fired insulating substrate by, for example, a sandblasting method, a wet etching method, a dry etching method, or the like, and then, the conductive paste may be applied, and fired. In addition, the first via conductor 13 may be formed by sputtering, vapor deposition, plating, or the like.

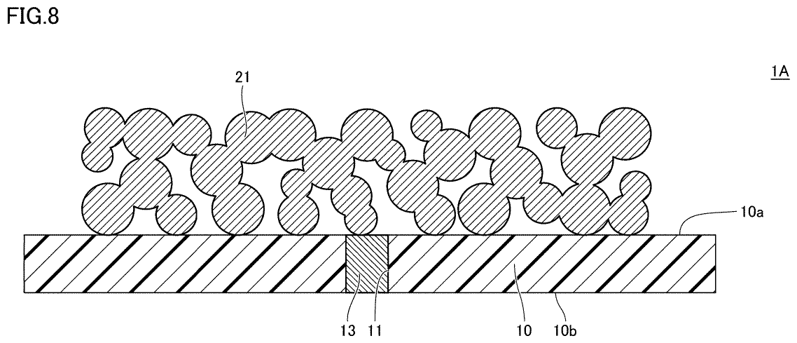

Next, as illustrated in FIGS. 6 and 8, in step S5, the metal porous body is formed. Specifically, as illustrated in FIG. 8, the metal porous body 21 is formed on the first main surface 10a of the insulating substrate 10.

More specifically, first, conductive metal particles, an organic solvent such as terpineol, and a varnish of ethyl cellulose are weighed and mixed, and the conductive paste is produced based on the mixture by using a roll machine. The conductive paste thus prepared is applied onto the first main surface 10a of the insulating substrate 10 and dried.

At this time, the conductive paste is overapplied a plurality of times, whereby the conductive paste is applied onto the first main surface 10a so as to have a predetermined thickness. The conductive paste is applied so as to have a rectangular pattern shape as a whole in plan view. The individual conductive paste applied onto the first main surface 10a is the metal porous body 21 described above.

Next, the insulating substrate 10 after being applied with the conductive paste is subjected to the degreasing treatment, and then the conductive paste is fired, for example, under a temperature condition of 400° C. to 900° C. in a reducing atmosphere in which nitrogen and hydrogen are mixed. Therefore, adjacent metal particles contained in the conductive paste form a neck, and as a result, the metal porous body 21 is formed.

Note that the atmosphere at the time of firing is preferably the reducing atmosphere as described above, but can be set to an atmosphere of an equilibrium oxygen partial pressure or less of a metal selected as a main component of the metal porous body 21.

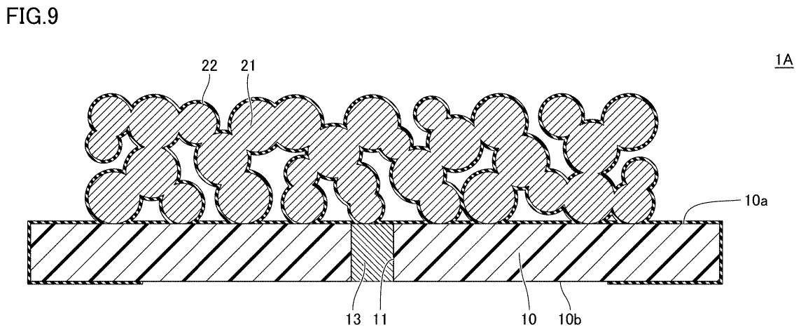

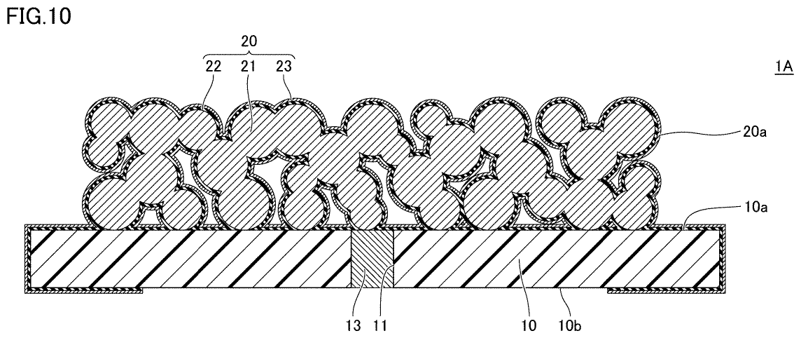

Next, as illustrated in FIGS. 6 and 9, a dielectric film is formed in step S6. Specifically, as illustrated in FIG. 9, the dielectric film 22 is formed so as to cover the first main surface 10a, the side surface, and the edge portion of the second main surface 10b of the insulating substrate 10 and the surface of the metal porous body 21.

A method for forming the dielectric film 22 is not particularly limited; however, an ALD method is preferably used. The use of the ALD method allows a raw material for the dielectric film 22 to be supplied as a gas, thus allowing the selection of the material and the adjustment of the film thickness at an atomic layer level.

In the case of forming the dielectric film 22 by using the ALD method, it is preferable to use, as a raw material gas, a raw material gas that is high in vapor pressure, easily turned into a gas, additionally, high in thermal stability, and high in reactivity. From this viewpoint, for example, when an AlOₓ film is formed, it is preferable to use trimethylaluminum (TMA) as a raw material. In the case of forming a SiOₓ film, it is preferable to use trisdimethylaminosilane (TDMAS) as a raw material. In the present embodiment, the dielectric film 22 made of AlSiO is formed by using the ALD method.

The dielectric film 22 is formed, for example, under a temperature condition of 150° C. or higher and 400° C. or lower although the conduction differs depending on the film forming method and the film forming material.

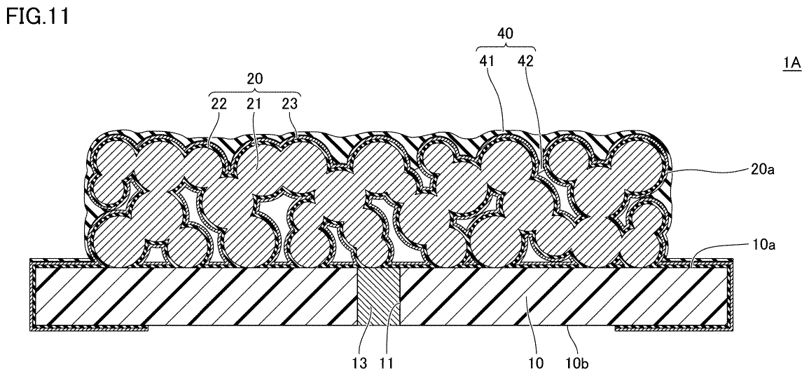

Next, as illustrated in FIGS. 6 and 10, a conductive film is formed in step S7. More specifically, the conductive film 23 is formed to cover the dielectric film 22 formed in step S6.

A method for forming the conductive film 23 is not particularly limited; however, an ALD method is preferably used. The use of the ALD method allows a raw material for the conductive film 23 to be supplied as a gas, thus allowing the selection of the material and the adjustment of the film thickness at an atomic layer level. Note that the conductive film 23 is formed, for example, under a temperature condition of 150° C. or higher and 600 or lower although the conduction differs depending on the film forming method and the film forming material. In the present embodiment, the conductive film 23 made of TiN is formed by using the ALD method.

Through steps S5 to S7 described above, as illustrated in FIG. 10, the capacitance forming part 20 including the conductive metal porous body 21, the dielectric film 22, and the conductive film 23 is formed on the first main surface 10a of the insulating substrate 10.

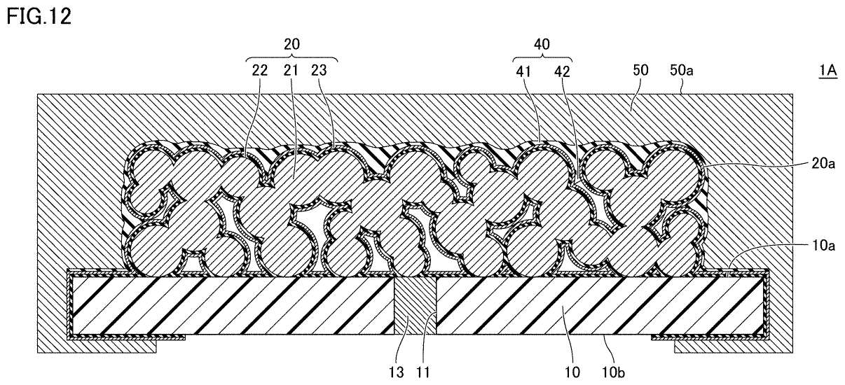

Next, as illustrated in FIGS. 6 and 11, an interposing film is formed in step S8. Specifically, the interposing film 40 is formed so as to cover the surface of the conductive film 23 in the portion defining the outer peripheral part 20a of the capacitance forming part 20 and to be located by entering the space inside the capacitance forming part 20.

A method for forming the interposing film 40 is not particularly limited; however, a CVD method is preferably used. In the present embodiment, the interposing film 40 made of Cu is formed by using the CVD method.

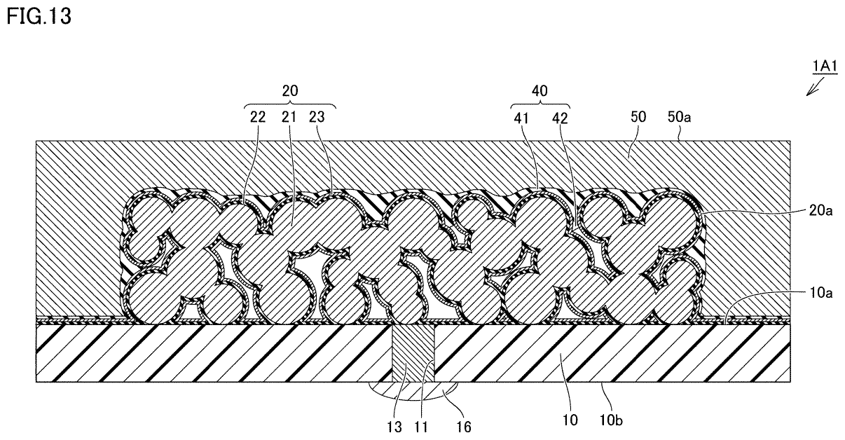

Next, as illustrated in FIGS. 6 and 12, a plating part is formed in step S9. Specifically, the plating part 50 is formed on the first main surface 10a of the insulating substrate 10 provided with the capacitance forming part 20 so as to cover the capacitance forming part 20. The plating part 50 is formed so as to cover most of the surface of the conductive film 23 of a portion located on the side surface of the insulating substrate 10 and the surface of the conductive film 23 of a portion located on the edge portion of the second main surface 10b. The plating part 50 is formed by any of various plating methods such as electrolytic plating.

By forming the plating part 50 in this manner, the capacitance forming part 20 is sealed by the insulating substrate 10 and the plating part 50. As a result, moisture can be prevented from entering the capacitance forming part 20 from the outside, and moisture resistance can be secured. The capacitance forming part 20 is covered with the plating part 50, and the capacitance forming part 20 is also physically protected by the plating part 50.

Next, as illustrated in FIG. 6, the first bump is formed on the insulating substrate in step S10. Specifically, as illustrated in FIG. 3, the first bump 16 is formed on the second main surface 10b of the insulating substrate 10 so as to cover the first via conductors 13 provided in the insulating substrate 10.

The first bump 16 can be formed by, for example, electrolytic plating. In this case, a portion other than the vicinity of the portion where the first via conductor 13 is exposed is covered with an ultraviolet curable resin film as a mask (not illustrated), and electrolytic plating is performed in this state, so that the first bump 16 can be formed to protrude from the second main surface 10b. Note that after completion of the electrolytic plating, the ultraviolet curable resin film as the mask is removed.

Note that a method for forming the first bump 16 is not limited to the method of using the electrolytic plating described above, and a combination of a screen printing method, inkjet method, dispenser method, or the like of using a conductive paste with firing can also be used. The first bump 16 may be formed, for example, after the above-described green sheet is fired (step S4).

The capacitor 1A according to the first embodiment described above is manufactured through steps S1 to S10 described above.

Here, in a capacitor including the capacitance forming part 20 and the plating part 50 sealing the capacitance forming part 20 as in the capacitor 1A according to the present embodiment, a plating solution for forming the plating part 50 may remain in a plurality of fine spaces provided inside the capacitance forming part 20. When the plating solution remains in the space inside the capacitance forming part 20 as described above, the function of the capacitor 1A may be impaired.

In this regard, in the capacitor 1A according to the present embodiment, as described above, the conductive interposing film 40 is interposed between the capacitance forming part 20 and the plating part 50. Thus, the plating part 50 is configured not to be in contact with the capacitance forming part 20.

With such a configuration, when the plating part 50 is formed in the manufacturing process of the capacitor 1A, the interposing film 40 becomes a physical obstacle, so that the intrusion of the plating solution into the space inside the capacitance forming part 20 can be effectively suppressed.

Therefore, it is possible to prevent a short circuit from occurring in the capacitance forming part 20 due to peeling of the capacitance forming part 20 from the insulating substrate 10 or dissolution of the metal porous body 21 caused by remaining of the plating solution in the space inside the capacitance forming part 20. As a result, it is possible to obtain the capacitor 1A achieving improved reliability after mounting in which the function of the capacitor is suppressed from being impaired due to such a short circuit.

Accordingly, the capacitor 1A according to the present embodiment will improve the reliability after mounting in the capacitor including the capacitance forming part including the metal porous body, the dielectric film, and the conductive film, and the plating part sealing the capacitance forming part.

In the capacitor 1A according to the present embodiment, as described above, the interposing film 40 includes not only the outer portion 41 located between the outer peripheral part 20a of the capacitance forming part 20 and the plating part 50 without entering the space inside the capacitance forming part 20, but also the inner portion 42 located by entering the space inside the capacitance forming part 20. This makes it possible to more effectively suppress the intrusion of the plating solution into the space inside the capacitance forming part 20 described above.

In the capacitor 1A according to the present embodiment, as described above, the distance between a portion of the outer portion 41 of the interposing film 40 in contact with the plating part 50 and the outer peripheral part 20a of the capacitance forming part 20 in the thickness direction of the interposing film 40 is preferably 100 nm or more. With such a configuration, it is possible to more reliably suppress the intrusion of the plating solution into the space inside the capacitance forming part 20 described above.

In the capacitor 1A according to the present embodiment, the distance between a portion of the inner portion 42 of the interposing film 40 which is the deepest in the space inside the capacitance forming part 20 and the outer peripheral part 20a of the capacitance forming part 20 in the thickness direction of the interposing film 40 is preferably 15 μm or less. With such a configuration, it is possible to provide a capacitor achieving improved reliability after mounting in which peeling of the capacitance forming part 20 from the insulating substrate 10 due to film stress generated in the interposing film 40 is more reliably suppressed.

Note that, in the capacitor 1A according to the present embodiment described above, a case where an electrical extension of the capacitance forming part 20 is performed from the plating part 50 of the portion formed in an annular shape along the edge portion of the second main surface 10b of the insulating substrate 10 has been described as an example. However, an electrical extension of the capacitance forming part 20 may be performed from the outer surface 50a of the plating part 50 or may be performed from the plating part 50 in a portion defining the side surface of the capacitor 1A.

As described above, by providing the plating part 50 sealing the capacitance forming part 20 as in the capacitor 1A according to the present embodiment, it is possible to dramatically improve the degree of freedom in setting the extending direction of electrical extension of the capacitance forming part 20.

### First Modification Example

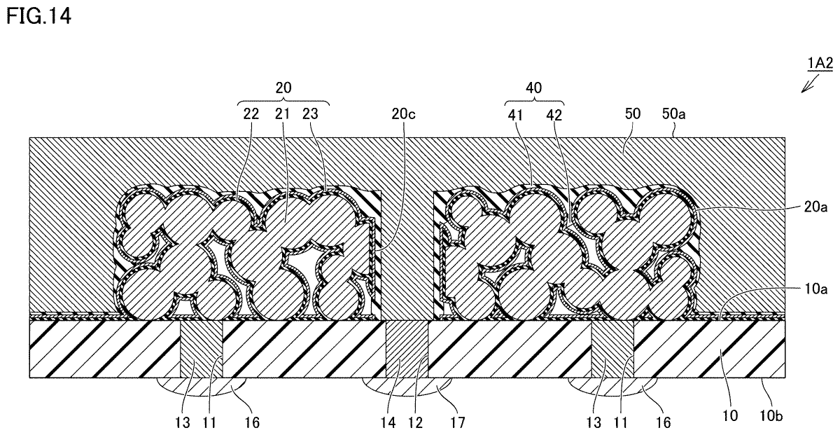

FIG. 13 is a schematic sectional view of a capacitor according to a first modification example. Hereinafter, a capacitor 1A1 according to the first modification example based on the first embodiment described above will be described with reference to FIG. 13.

As illustrated in FIG. 13, the capacitor 1A1 according to the first modification example is different from the capacitor 1A according to the above-described first embodiment in the configurations of the dielectric film 22, the conductive film 23, and the plating part 50.

More specifically, in the capacitor 1A1 according to the present modification example, the dielectric film 22, the conductive film 23, and the plating part 50 are not provided on any of the side surface and the second main surface 10b of the insulating substrate 10.

Therefore, in the capacitor 1A1, an electrical extension of the capacitance forming part 20 is performed from the first bump 16 and the outer surface 50a of the plating part 50. Alternatively, in the capacitor 1A1, an electrical extension of the capacitance forming part 20 may be performed from the first bump 16 and the plating part 50 in a portion defining the side surface of the capacitor 1A1. That is, in the capacitor 1A1, the bottom surface and the top surface of the capacitor 1A1 are configured as mounting surfaces for a wiring board or the like, or the bottom surface and the side surface of the capacitor 1A1 are configured as mounting surfaces for a wiring board or the like.

Also in the case of such a configuration, an effect that is similar to the effect described in the first embodiment described above will be achieved, and the reliability after mounting will be improved in the capacitor including the capacitance forming part including the metal porous body, the dielectric film, and the conductive film and the plating part sealing the capacitance forming part.

Note that, in a method for manufacturing the capacitor 1A1 according to the first modification example, the capacitor can be manufactured basically in accordance with the method for manufacturing the capacitor 1A according to the first embodiment described above.

### Second Modification Example

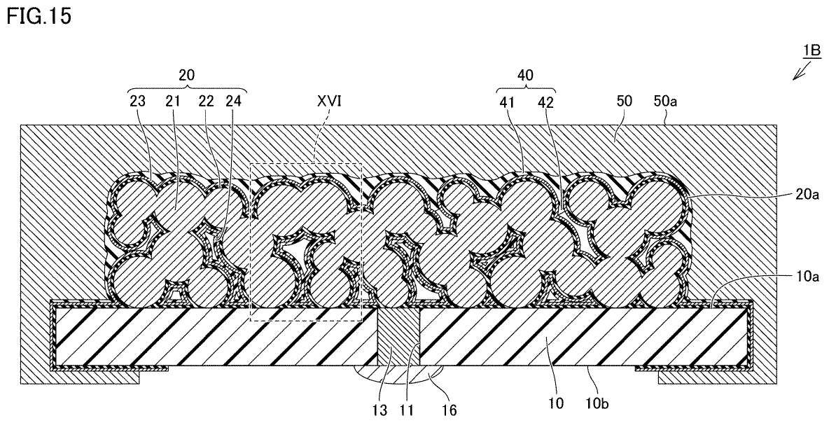

FIG. 14 is a schematic sectional view of a capacitor according to a second modification example. Hereinafter, a capacitor 1A2 according to the second modification example based on the first embodiment described above will be described with reference to FIG. 14.

As illustrated in FIG. 14, the capacitor 1A2 according to the second modification example is different from the capacitor 1A according to the above-described first embodiment in the configurations of the capacitance forming part 20 and the second external connection line.

More specifically, in the capacitor 1A2 according to the present modification example, a through-hole 20c is provided in the capacitance forming part 20. The through-hole 20c penetrates the capacitance forming part 20 so as to reach from one end to the other end in the height direction of the capacitance forming part 20.

The through-hole 20c is filled with the plating part 50. The interposing film 40 is interposed between the plating part 50 of a portion embedded in the through-hole 20c and the capacitance forming part 20 in a portion defining the through-hole 20c.

In the capacitor 1A2 according to the present modification example, the second external connection line further includes a second via conductor 14 and a second bump 17 provided in the insulating substrate 10 in addition to the interposing film 40 and the plating part 50 described above.

More specifically, when the capacitor 1A2 is viewed in plan view, the second through-hole 12 is provided in the insulating substrate 10 in a portion overlapping the plating part 50 of the portion embedded in the through-hole 20c. The second through-hole 12 penetrates the insulating substrate 10 so as to reach the second main surface 10b from the first main surface 10a.

The second through-hole 12 is filled with the second via conductor 14. The second via conductor 14 has, for example, a substantially columnar shape. The material, shape, and the like of the second via conductor 14 are configured similarly to the first via conductor 13 described above, for example.

The second bump 17 is provided on the second main surface 10b of the insulating substrate 10 so as to cover the second via conductor 14. The second bump 17 is provided to protrude from the second main surface 10b of the insulating substrate 10. The shape of the second bump 17 is substantially hemispherical. The material, shape, and the like of the second bump 17 are configured similarly to the first bump 16 described above, for example.

That is, in the present modification example, the first bump 16 and the second bump 17 define a bottom surface of the capacitor 1A2, so that the bottom surface thereof is configured as a mounting surface for a wiring board or the like.

Also in the case of such a configuration, an effect that is similar to the effect described in the first embodiment described above will be achieved, and the reliability after mounting will be improved in the capacitor including the capacitance forming part including the metal porous body, the dielectric film, and the conductive film and the plating part sealing the capacitance forming part.

Note that, the capacitor 1A2 according to the second modification example can be manufactured basically in accordance with the method for manufacturing the capacitor 1A according to the first embodiment described above.

As an example, the second through-hole is formed simultaneously with step S2 (formation of the first through-hole) described above. The second via conductor is formed simultaneously with step S3 (formation of the first via conductor). After step S7 is performed and before step S8 is performed (after the formation of the conductive film and before the formation of the interposing film), a through-hole is provided in the capacitance forming part. In step S8, the interposing film is formed so as to also cover the capacitance forming part in the portion defining the through-hole. In step S9, the plating part 50 is formed so as to also embed the through-hole 20c.

By manufacturing the capacitor 1A2 as described above, as described above, the interposing film 40 is also interposed between the plating part 50 in the portion embedded in the through-hole 20c and the capacitance forming part 20 in the portion defining the through-hole 20c.

### Second Embodiment

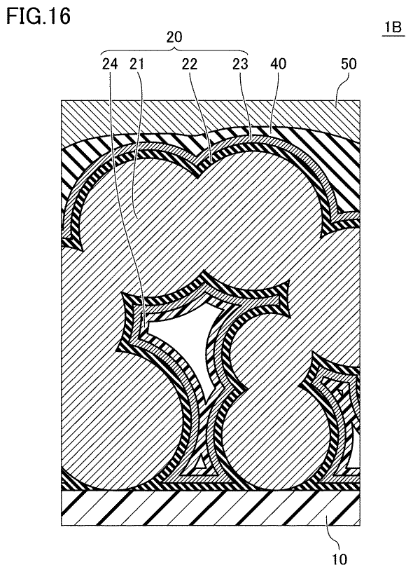

FIG. 15 is a schematic sectional view of a capacitor according to a second embodiment. FIG. 16 is an enlarged sectional view of a main part of region XVI in the capacitor illustrated in FIG. 15. Hereinafter, a capacitor 1B according to the present embodiment will be described with reference to FIGS. 15 and 16.

As illustrated in FIGS. 15 and 16, the capacitor 1B according to the present embodiment is different from the capacitor 1A according to the above-described first embodiment in the configuration in the capacitance forming part 20.

More specifically, in the capacitor 1B according to the present embodiment, the capacitance forming part 20 further includes a water repellent film 24. As will be described in detail later, the water repellent film 24 may cover only the conductive film 23 in a portion defining the space inside the capacitance forming part 20 depending on its electrical properties, or may cover the conductive film 23 in the portion defining the outer peripheral part 20a of the capacitance forming part 20 in addition to this. In the present embodiment, the insulating water repellent film 24 covers only the conductive film 23 in the portion defining the space inside the capacitance forming part 20.

The water repellent film 24 may be made of an insulating material or a conductive material. In the case of the insulating water repellent film 24, the water repellent film 24 can be made of, for example, a silane coupling agent or a material such as an organic fluorine compound. In the case of the conductive water repellent film 24, the water repellent film 24 can be made of, for example, a material such as a fluorinated compound. In the present embodiment, the insulating water repellent film 24 made of a silane coupling agent is used.

A method for forming the water repellent film 24 is not particularly limited, but the water repellent film 24 is preferably formed by an impregnation method. The thickness of the water repellent film 24 is not particularly limited, and is preferably 10 nm to 1 μm.

When the capacitance forming part 20 includes the water repellent film 24 as described above, the distance (see the distance d1 in FIG. 4) between a portion of the outer portion 41 of the interposing film 40 in contact with the plating part 50 and the outer peripheral part 20a of the capacitance forming part 20 in the thickness direction of the interposing film 40 may be configured to be smaller than the distance when the capacitance forming part 20 does not include the water repellent film 24 as in the capacitor 1A according to the first embodiment described above. This is because the water repellent film 24 has a function of suppressing the intrusion of the plating solution into the space inside the capacitance forming part 20, similarly to the interposing film 40. Therefore, in the present embodiment, the distance is preferably 50 nm or more.

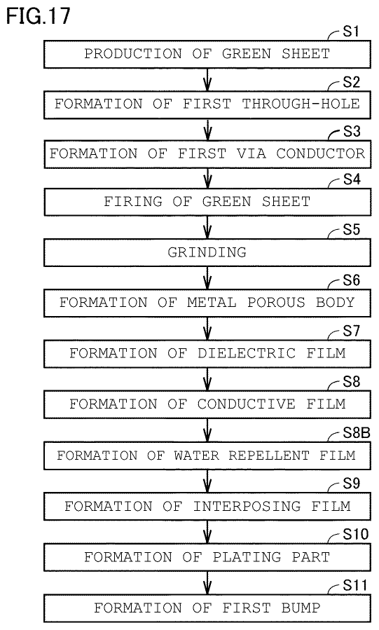

FIG. 17 is a flowchart illustrating a method for manufacturing the capacitor according to the second embodiment. Next, an example of a specific manufacturing method for manufacturing the capacitor 1B according to the present embodiment described above will be described with reference to FIG. 17.

As illustrated in FIG. 17, the method for manufacturing the capacitor 1B mostly conforms to the method for manufacturing the capacitor 1A. Accordingly, in the following description, in the method for manufacturing the capacitor 1B, the description of steps that have contents in common to the method for manufacturing the capacitor 1A will be omitted, and only steps that have different contents from the method for manufacturing the capacitor 1A will be described.

As illustrated in FIG. 17, after the conductive film is formed in step S8, a water repellent film is formed in step S8B. More specifically, the insulating water repellent film 24 is formed so as to cover only the conductive film 23 in the portion defining the space inside the capacitance forming part 20.

Here, when the water repellent film 24 has an insulating property, the water repellent film 24 is preferably formed so as not to cover the conductive film 23 in the portion defining the outer peripheral part 20a of the capacitance forming part 20. This is because the conductive film 23, the water repellent film 24, and the conductive interposing film 40 are laminated in this order to form a so-called metal insulator metal (MIM) structure, thereby preventing an unintended capacitance forming part from being formed in the capacitor 1B.

Therefore, in step S8B, for example, it is preferable to form the water repellent film 24 after applying a mask to the conductive film 23 in the portion defining the outer peripheral part 20a of the capacitance forming part 20, or to form the water repellent film 24 while controlling the penetration depth of the water repellent film 24 to a desired depth. Thus, the insulating water repellent film 24 can be formed so as to cover only the conductive film 23 in the portion defining the space inside the capacitance forming part 20.

Also in the capacitor 1B according to the present embodiment configured as described above, an effect that is similar to the effect described in the first embodiment described above will be achieved, and the reliability after mounting will be improved in the capacitor including the capacitance forming part including the metal porous body, the dielectric film, and the conductive film and the plating part sealing the capacitance forming part.

In the case of such a configuration, when the plating part 50 is formed in the manufacturing process of the capacitor 1B, the interposing film 40 becomes a physical obstacle, so that not only the intrusion of the plating solution into the space inside the capacitance forming part 20 can be suppressed, but also the intrusion of the plating solution can be suppressed by the water repellency of the water repellent film 24.

Note that, in the present embodiment described above, a case where the capacitance forming part 20 includes the insulating water repellent film 24 has been described as an example; however, as described above, the water repellent film 24 may have conductivity.

In this case, the water repellent film 24 may be formed so as to cover not only the conductive film 23 in the portion defining the space inside the capacitance forming part 20 but also the conductive film 23 in the portion defining the outer peripheral part 20a of the capacitance forming part 20. When the water repellent film 24 has conductivity, an unintended capacitance forming part as described above is not formed in the capacitor 1B.

### (Supplement)

The characteristic configurations of the capacitor disclosed in the above-described embodiments and the modification examples thereof are summarized as follows.

### [Supplement 1]

A capacitor including: an insulating substrate having a first main surface; a capacitance forming part on the main surface, the capacitance forming part including a conductive metal porous body, a dielectric film covering a surface of the conductive metal porous body, and a conductive film covering the dielectric film; a first external connection line connected to the conductive metal porous body; and a second external connection line connected to the conductive film, the second external connection line including a conductive plating part on an outer peripheral part of the capacitance forming part, and a conductive interposing film interposed between the capacitance forming part and the plating part, wherein the capacitance forming part is sealed by the insulating substrate and the conductive plating part.

### [Supplement 2]

The capacitor according to Supplement 1, wherein the interposing film includes an inner portion entering a space inside the capacitance forming part, and an outer portion located between the outer peripheral part of the capacitance forming part and the conductive plating part without entering the space inside the capacitance forming part.

### [Supplement 3]

The capacitor according to Supplement 2, wherein a first distance between a first portion of the inner portion of the interposing film which is deepest in the space inside the capacitance forming part and the outer peripheral part of the capacitance forming part in a thickness direction of the interposing film is 15 μm or less.

### [Supplement 4]

The capacitor according to Supplement 2 or 3, wherein a distance between a second portion of the outer portion of the interposing film in contact with the conductive plating part and the outer peripheral part of the capacitance forming part in the thickness direction of the interposing film is 100 nm or more.

### [Supplement 5]

The capacitor according to Supplement 2 or 3, further including an insulating water repellent film that covers only the conductive film in a portion thereof defining the space inside the capacitance forming part.

### [Supplement 6]

The capacitor according to Supplement 2 or 3, further including a conductive water repellent film that covers at least the conductive film in a portion thereof defining the space inside the capacitance forming part.

### [Supplement 7]

The capacitor according to Supplement 5 or 6, wherein a distance between a portion of the outer portion of the interposing film in contact with the conductive plating part and the outer peripheral part of the capacitance forming part in a thickness direction of the interposing film is 50 nm or more.

### (Other Modes, Etc.)

The shape, configuration, size, number, material, and the like of each of the parts described in the above-described embodiments of the present disclosure can be variously changed without departing from the scope of the present disclosure.

In addition, the characteristic configurations described in the above-mentioned embodiments of the present disclosure can be naturally combined with each other within an allowable range in light of the scope of the present disclosure.

As described above, the above embodiment disclosed this time is illustrative in all points and not restrictive. The technical scope of the present disclosure is defined by the claims, and considered including all modifications within the meaning and scope equivalent to the description of the claims.

### DESCRIPTION OF REFERENCE SYMBOLS

1A, 1A1, 1A2, 1B: Capacitor
10: Insulating substrate
10a: First main surface
10b: Second main surface
11: First through-hole
12: Second through-hole
13: First via conductor
14: Second via conductor
16: First bump
17: Second bump
20: Capacitance forming part
20a: Outer peripheral part
20c: Through-hole
21: Metal porous body
22: Dielectric film
23: Conductive film
24: Water repellent film
40: Interposing film
41: Outer portion
42: Inner portion
50: Plating part
50a: Outer surface

1. A capacitor comprising:
an insulating substrate having a first main surface;
a capacitance forming part on the main surface, the capacitance forming part including a conductive metal porous body, a dielectric film covering a surface of the conductive metal porous body, and a conductive film covering the dielectric film;
a first external connection line connected to the conductive metal porous body; and
a second external connection line connected to the conductive film, the second external connection line including a conductive plating part on an outer peripheral part of the capacitance forming part, and a conductive interposing film interposed between the capacitance forming part and the plating part, wherein
the capacitance forming part is sealed by the insulating substrate and the conductive plating part.

2. The capacitor according to claim 1, wherein the interposing film includes an inner portion entering a space inside the capacitance forming part, and an outer portion between the outer peripheral part of the capacitance forming part and the conductive plating part without entering the space inside the capacitance forming part.

3. The capacitor according to claim 2, wherein a first distance between a first portion of the inner portion of the interposing film which is deepest in the space inside the capacitance forming part and the outer peripheral part of the capacitance forming part in a thickness direction of the interposing film is 15 μm or less.

4. The capacitor according to claim 3, wherein a distance between a second portion of the outer portion of the interposing film in contact with the conductive plating part and the outer peripheral part of the capacitance forming part in the thickness direction of the interposing film is 100 nm or more.

5. The capacitor according to claim 2, wherein a distance between a portion of the outer portion of the interposing film in contact with the conductive plating part and the outer peripheral part of the capacitance forming part in the thickness direction of the interposing film is 100 nm or more.

6. The capacitor according to claim 2, further comprising an insulating water repellent film that covers only the conductive film in a portion thereof defining the space inside the capacitance forming part.

7. The capacitor according to claim 6, wherein a distance between a portion of the outer portion of the interposing film in contact with the conductive plating part and the outer peripheral part of the capacitance forming part in a thickness direction of the interposing film is 50 nm or more.

8. The capacitor according to claim 2, further comprising a conductive water repellent film that covers at least the conductive film in a portion thereof defining the space inside the capacitance forming part.

9. The capacitor according to claim 8, wherein a distance between a portion of the outer portion of the interposing film in contact with the conductive plating part and the outer peripheral part of the capacitance forming part in a thickness direction of the interposing film is 50 nm or more.

10. The capacitor according to claim 1, wherein the insulating substrate includes a first through-hole that penetrates the insulating substrate from the first main surface to a second main surface, and the first external connection line includes a first via conductor in the first through-hole.

11. The capacitor according to claim 10, wherein the insulating substrate includes a second through-hole in a portion overlapping the conductive plating part, the second through-hole penetrating the insulating substrate from the first main surface to the second main surface, and the second external connection lines includes a second via conductor in the second through-hole.

12. The capacitor according to claim 1, wherein
the insulating substrate includes a second main surface opposite the first main surface, and a side surface connecting the first main surface to the second main surface,
the dielectric film covers the side surface of the insulating substrate and an edge portion of the second main surface,
the conductive film covers the surface of the dielectric film covering the side surface of the insulating substrate and the edge portion of the second main surface, and
the conductive plating part covers the surface of the conductive film on the side surface of the insulating substrate and the edge portion of the second main surface.
